(19) United States
(12) Patent Application Publication
(10) Pub. No.: US 2008/0150449 A1
(43) Pub. Date: Jun. 26, 2008

(54) CONTROL CIRCUITS FOR DIMMING CONTROL

(75) Inventors: Chia-Wei Wang, Taipei (TW); Shih-Chung Huang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEYOND INNOVATION TECHNOLOGY CO., LTD., Taipei (TW)

(21) Appl. No.: 11/940,448

(22) Filed: Nov. 15, 2007

(30) Foreign Application Priority Data
Dec. 26, 2006 (TW) 95148965

(51) Int. Cl. H05B 41/36

(52) U.S. Cl. 315/291; 315/294

(57) ABSTRACT

A control circuit for controlling a current flow through a load is disclosed. The circuit comprises a power converter, a controller and a current control circuit. The power converter converts a first voltage signal to a second voltage signal according to a control signal. The controller couples to the power converter and adjusts the control signal according to the second voltage signal so that the second voltage signal is maintained at a predetermined value. The current control circuit is coupled to the load, and controls the current flow through the load according to a dimming signal to control the load.

### BACKGROUND OF THE INVENTION

1. Field of the Invention

The invention relates to control circuits, and more precisely, to control circuits for a light emitting diodes (LEDs).

2. Description of the Related Art

A dimming control circuit is widely used in luminance control of various display devices, such as liquid crystal display (LCD) panels or LED modules. The dimming control circuit is a well-known control circuit that utilizes an external dimming signal to control the magnitude of the voltage or the current flow through a load for generating different luminances. In one common control circuit for an LED, a constant current is applied to the LED to determine the luminance thereof. Such control circuit usually includes a power converter, a controller and a current detection circuit. The power converter comprises at least one switch element, one diode, one inductor and one output capacitor, and the controller comprises at least one resistor-capacitor (RC) circuit consisting of at least one capacitor. The controller generates a control signal and compares a current flow through the LED detected by the current detection circuit with a reference voltage so as to adjust the control signal. In addition, the control signal turns on or off the switch element of the power converter, and converts an inputted voltage to an output signal through the LED, the inductor and the capacitor in the power converter for driving the LED while keeping the current stable by adjusting the control signal. Then, a dimming signal (e.g., a pulse width modulation (PWM) signal) is inputted to the controller such that the controller adjusts the current supplied to the LED in response to the dimming signal so as to adjust the luminance of the LED.

For the aforementioned control circuit, due to the time delay effects of the dimming signal caused when the dimming signal passes through the delay elements (e.g., switch element and capacitor) in the power converter, the ratio of the dimming signal to the current supplied to the LED corresponding to the dimming signal becomes non-linear. For example, the current signal outputted to the LED may generate a rising or a falling slope because of the charge/discharge characteristics of the capacitor. In this case, charges remaining in the capacitor will still provide current to the LED even if the switch element is turned off by the control signal such that the LED will not completely turn off till after a certain time period. Therefore, the expected control of the luminance fails and the performance of the dimming circuit is reduced.

### BRIEF SUMMARY OF THE INVENTION

It is therefore desired to provide control circuits for controlling the current supplied to the load such that current flow through the load can be varied according to the variation of the dimming signal without time delay so as to obtain better dimming control.

An embodiment of the invention provides a control circuit for controlling a current flow through a load. The control circuit comprises a power converter, a controller and a current control circuit. The power converter converts a first voltage signal to a second voltage signal in response to a control signal. The controller is coupled to the power converter, adjusting the control signal in response to the second voltage signal such that the second voltage signal is held at a predetermined level. The current control circuit is coupled to the load, controlling the current flow through the load according to a dimming signal.

The embodiment of the invention also provides a control circuit for controlling current flow through a first load and a second load. The control circuit comprises a power converter, a controller, first and second current control circuits and a phase shift circuit. The power converter converts a first voltage signal to a second voltage signal in response to a control signal. The controller is coupled to the power converter to adjust the control signal in response to the second voltage signal such that the second voltage signal is held at a predetermined level. The first current control circuit is coupled to the first load for controlling the current flow through the first load while the second current control circuit is coupled to the second load for controlling the current flow through the second load. The phase shift circuit generates a first control signal with a first phase and a second control signal with a second phase other than the first phase in response to a dimming signal. The first current control circuit is controlled by the first control signal to control the current flow through the first load and the second current control circuit is controlled by the second control signal to control the current flow through the second load.

The embodiment of the invention further provides a control circuit for controlling current flow through a first load and a second load, comprising a power converter, a controller, first and second current control circuits and a phase shift circuit. The power converter converts a first voltage signal to a second voltage signal in response to a control signal. The controller is coupled to the power converter, and adjusts the control signal in response to the second voltage signal such that the second voltage signal is held at a predetermined level. The first and second current control circuits are respectively coupled to the first and second loads, controlling the current flow through the first and second loads, respectively. The phase shift circuit generates at least one control signal with a phase other than the phase of the dimming signal in response to a dimming signal. The first current control circuit controls the current flow through the first load by the dimming signal, and the second current control circuit controls the current flow through the second load by the control signal.

### BRIEF DESCRIPTION OF THE DRAWINGS

The invention can be more fully understood by reading the subsequent detailed description and examples with reference to the accompanying drawings, wherein:

FIG. 1 schematically shows an embodiment of a control circuit;

FIG. 2 schematically shows an embodiment of a control circuit according to the invention;

FIG. 3 schematically shows an embodiment of a control circuit according to the invention in detail;

FIG. 4 schematically shows another embodiment of a control circuit according to the invention;

FIG. 5 is a block diagram of an embodiment of a control circuit according to the invention;

FIG. 6 is a block diagram of another embodiment of a control circuit according to the invention;

FIG. 7 schematically shows an embodiment of a dimming signal according to the invention; and

FIG. 8 is a block diagram of yet another embodiment of a control circuit according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

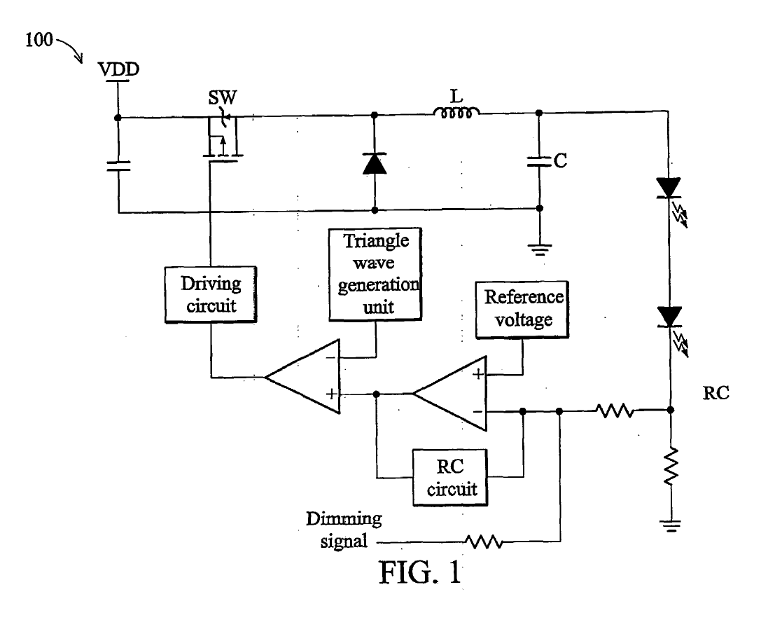

The invention is described with reference to FIGS. 1 through 8, which generally relate to a control circuit for an LED. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. It should be understood that many of the elements described and illustrated throughout the specification are functional in nature and may be embodied in one or more physical entities or may take other forms beyond those described or depicted.

The embodiments of the invention provide control circuits for controlling a current flow through a load, such as an LED. In one embodiment, a control circuit is provided. The control circuit controls the current supplied to the load and receives a dimming signal such that the current flow through the load can be varied immediately according to the variation of the dimming signal without time delay so as to obtain better dimming control performance. As such, embodiments of the invention maintain supply voltage stability by using a voltage feed back from the load as a major feedback signal, and using the dimming signal to directly input to a current control circuit, such as a current mirror circuit, to control the current flow through the load directly for adjusting luminance of the load. In the embodiments of the invention, the current controlled by the current control circuit will no longer feed back to the delay elements (e.g. a switch element, a capacitor or the like). According, there is no time delay problem, and better linearity of the current supplied to the LED is obtained. Particularly, if the dimming signal is at a low voltage level, the current supplied to the load can be rapidly reduced to zero so that the load is accordingly turned off, thereby resulting in better dimming control performance.

In one embodiment of the invention, a control circuit having a phase shifting circuit for use in a multi-load circuit having at least two loads is provided such that the control circuit is capable of applying the dimming signal to generate several control signals, each with a different phase, to control each of the current control circuits for driving each of the loads.

FIG. 1 schematically shows an embodiment of a control circuit 100. Note that the control circuit 100 is the circuit shown in the FIG. 1 excluding the load. In other words, the control circuit 100 does not include any load. As shown in FIG. 1, current of the load (such as a LED in this embodiment) is detected by the control circuit 100 and is compared to a reference voltage for adjusting a control signal to control the switch element SW by a driving circuit such that the inputted supply voltage VDD is converted to an output voltage signal through a rectifying diode, and an inductor L and an output capacitor C supply a current to the load. An RC circuit is utilized to control feedback compensation and adjust pulse width of the control signal by comparing a triangle wave signal through a comparator for maintaining the stability of the current supplied to the load. The dimming signal is coupled to a detected current of the load to control the magnitude of the current flow through the load so as to adjust the luminance of the load.

In the control circuit 100, the output signal for the load however, may not vary according to variation of the dimming signal since the circuit loop comprising at least the RC circuit, the switch element SW and the output capacitor C, wherein the dimming signal transmits through to obtain an output signal, contains delay characteristics causing signal delay. For example, if the dimming signal is at a high voltage level, the switch element SW is turned off. Although the switch element SW has been turned off however, due to the charges remaining in the output capacitor C, the load may not be turned off until the output capacitor C is discharged to a certain level for a certain time period. Due to such signal delay, performance of adjusting the luminance of the load may be poor.

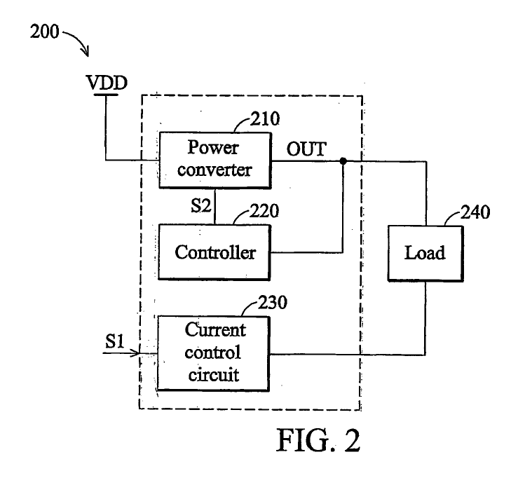

FIG. 2 is a schematic 200 showing an embodiment of a control circuit according to the invention. As shown, the control circuit of this embodiment comprises a power converter 210, a controller 220 and a current control circuit 230 for controlling a load 240. It is to be noted that the control circuit of the present invention shown in the FIG. 2 is represented by a dotted line area including the power converter 210, the controller 220 and the current control circuit 230 while excluding the load 240. The load helps to illustrate the operation of the control circuit and relationship between the control circuit and the load. For simplification, the loads shown in the figures below are excluded in the control circuit of the invention.

The controller 220 generates a control signal S2 which may be a pulse width modulation (PWM) signal. The power converter 210 is coupled to the controller 220 and the load 240, converting the inputted supply voltage VDD to an output voltage signal OUT for the load 240 in response to the control signal S2 generated by the controller 220, and then generates a feedback signal to the controller 220 according to the output voltage signal OUT. Therefore, the controller 220 is capable of adjusting the pulse width of the control signal S2 based on the feedback signal such that the power converter 210 outputs a stable voltage.

In this embodiment, the current control circuit 230 is coupled to the load 240 and controls the magnitude of the current flow through the load 240 in response to a voltage level of a received dimming signal S1. When the dimming signal S1 is at a high voltage level, the current control circuit 230 outputs a current to drive the load 240. Meanwhile, the output voltage signal OUT remains at a predetermined voltage level under the control of the controller 220. When the dimming signal S1 is at a low voltage level, no current is generated to the load 240 by the current control circuit 230 (i.e. the current flow through the load 240 is zero) so that the load 240 will be immediately turned off. Since the controller 220 feeds back the output voltage signal OUT as a major feedback control source, the controller 220 and the output voltage signal OUT will not be affected even though the current flow through the load 240 is zero. Thus, the output voltage signal OUT will still remain at a predetermined voltage level. In other words, the load 240 is supplied with a constant voltage without any affect from the dimming signal S1. In other embodiments, the dimming signal may be implemented as a direct current signal other than a pulse width modulation signal used in this embodiment.

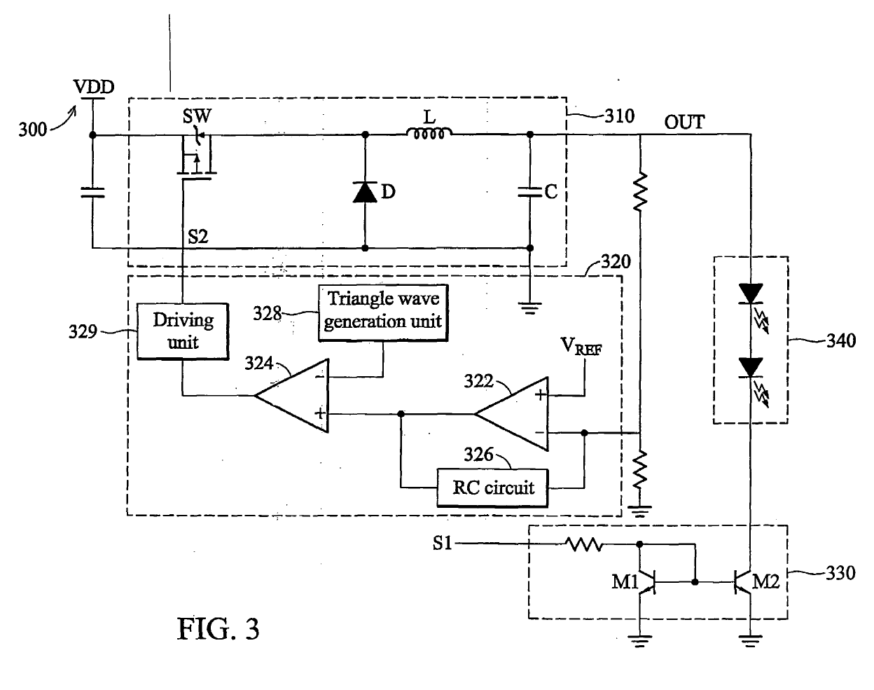

FIG. 3 shows a detailed schematic of an embodiment of a control circuit 300 according to the invention. The control circuit 300 comprises a power converter 310, a controller 320 and a current control circuit 330 for controlling an LED module 340. The power converter 310 is coupled to the controller 320 and the LED module 340 while the current control circuit 330 is coupled to the LED module 340. Moreover, the dimming signal S1 is inputted to the current control circuit 330. It is to be understood that, in this embodiment, although the power converter is a buck converter, the load is a LED module 340 and the dimming signal is a pulse width modulation signal, the invention is not limited thereto.

The power converter 310 at least comprises a rectifying element (e.g. a rectifying diode D), an inductor L, an output capacitor C, and a switch element SW. The switch element SW has a first input end, a second input end and a control end in which the first input end receives an input voltage signal VDD. The cathode of the rectifying diode D is coupled to the second input end of the switch element SW and the anode of the rectifying diode D is coupled to the ground. One end of the inductor L is coupled to the cathode of the rectifying diode D and the other end is coupled to one end of the capacitor. During operation, the switch element SW receives a control signal S2 generated by the controller 320 to convert the inputted voltage signal VDD to a square wave, and then converts the square wave to an output signal OUT via the rectifying diode D, the inductor L and the capacitor C.

In this embodiment, the controller 320 comprises a reference voltage V_{REF}, an error amplifier 322, a comparator 324, a feedback compensation circuit (e.g. RC circuit 326), a signal generation unit (e.g. triangle wave generation unit 328), and a driving circuit 329. The error amplifier 322 has a positive end and a negative end wherein the negative end receives a feedback signal generated in response to the output voltage signal OUT outputted by the power converter 310, and the positive end is coupled to the reference voltage V_{REF}. The error amplifier 322 compares the feedback signal received by the negative end and the reference voltage V_{REF} of the positive end, and performs signal compensation and feedback control using the RC circuit 326 for outputting an adjusting signal.

The comparator 324 has a positive end and a negative end wherein the positive end receives the adjusting signal from the error amplifier 322, and the negative end receives a triangle wave signal generated by the triangle wave generation unit 328. The comparator 324 adjusts the pulse width of the control signal S2 by comparing the adjusting signal with the triangle wave signal. The driving circuit 329 controls turning on or off of the switch element SW within the power converter 310 (which generate the output voltage signal OUT), according to the control signal S2. The signal generation unit may be, for example, a saw wave generation unit (not shown) for generating a comparison signal with a saw wave.

The current control circuit 330 at least comprises two switch elements M1 and M2 coupled to the dimming signal S1, and the dimming signal S1 is inputted to the current control circuit 330. In this embodiment, the current control circuit 330 is implemented as a current mirror circuit; however, it may be implemented as any current adjusting circuit capable of adjusting the currents.

Meanwhile, the dimming signal S1 is coupled to the current control circuit 330 so that the switch elements M1 and M2 of the current control circuit 330 will be turned on when the dimming signal S1 is at a high voltage level. Accordingly, the current across the switch element M1 forces a current proportional to the current across the switch element M1 to be generated across the switch element M2 to control the current flow through the LED module 340 for driving the LED module 340 such that the LED module 340 illuminates light according to the high voltage level of the dimming signal S1. When the dimming signal S1 is at a low voltage level, the switch elements M1 and M2 of the current control circuit 330 will be turned off at the same time such that the negative end of the LED module 340 is opened. In this case, although charges in the output capacitor C of the power converter 310 still remains, no current is supplied to the LED module 340 due to path elimination for discharging. Therefore, the LED module 340 is turned off immediately according to the low voltage level of the dimming signal S1.

For example, assume that the dimming signal S1 is a pulse width modulation signal which has a voltage 2V as a high voltage level and a voltage 0V as a low voltage level, the LED module 340 will receive a current, e.g. −20 mA, so it's turned on when the dimming signal is 2V. When the dimming signal is 0V, the current flow through the LED module 340 will soon become zero, so the LED module 340 is turned off. Therefore, current flow through the LED module 340 is varied according to the variation of dimming signal S1 without being affected by the delay effects generated by delay elements, achieving better linearity between the current flow through the LED module 340 and the dimming signal S1. It is to be understood that, in this control circuit, the delay effect may be generated by, in addition to the capacitor C of the power converter 310, the RC circuit 326 of the controller 320 or the switch element SW of the power converter 310 in which the delay effect generated by the capacitor C is larger then others. The delay effect from any elements can be avoided by applying the present invention.

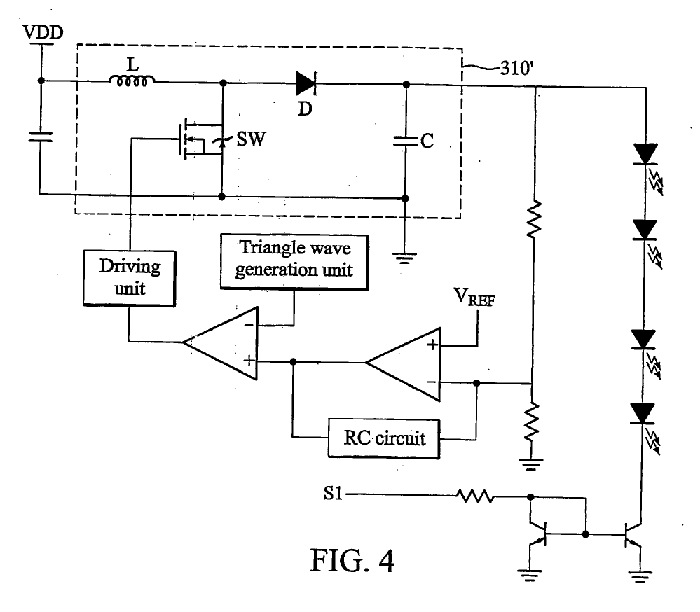

Additionally, the power converter 310 may be replaced by a boost converter 310′ (as shown in FIG. 4) if the operational voltage for the LED module is larger than the inputted voltage. FIG. 4 shows a schematic of another embodiment of a control circuit according to the invention in which the power converter 310′ is a boost converter. The current control circuit of the present invention is utilized to control whether to conduct the current of the load irrelevant of power converter type (e.g. boost converter or buck converter) utilized. Thus, as discussed above for the control circuit 300, the circuit configuration in this embodiment will also achieve better linearity between the current flow through the LED module 340 and the dimming signal S1.

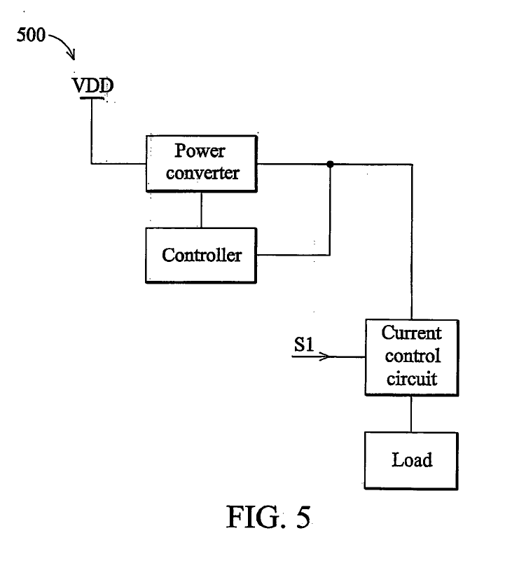

FIG. 5 is a block diagram of an embodiment of a control circuit 500 according to the invention. Referring to FIGS. 2 and 5, circuit configuration and operation for the block diagram 500 of FIG. 5 are similar to those for the block diagram 200 of FIG. 2 except that the dimming signal S1 and the current control circuit are coupled to the high voltage end of the load instead of the low voltage end. In this case, by selecting a proper structure of the current control circuit, current flow through the load can be controlled to be varied according to the variation of dimming signal S1 without being affected by the delay effects generated by the delay element (i.e., the output capacitor C) of the power converter. Therefore, current control circuit of the present invention can be configured to any end (low voltage end or high voltage end) of the load.

Moreover, for a circuit with multiple loads, large ripple wave of the current will be generated since all of the loads are simultaneously turned on or off. To reduce the ripple wave of the current, in the present invention, a phase shifting circuit is utilized to generate control signals with different phase, each for one of the current control circuits, such that there is a time difference between the turn on and off operations for each load so as to reduce the magnitude of the ripple wave.

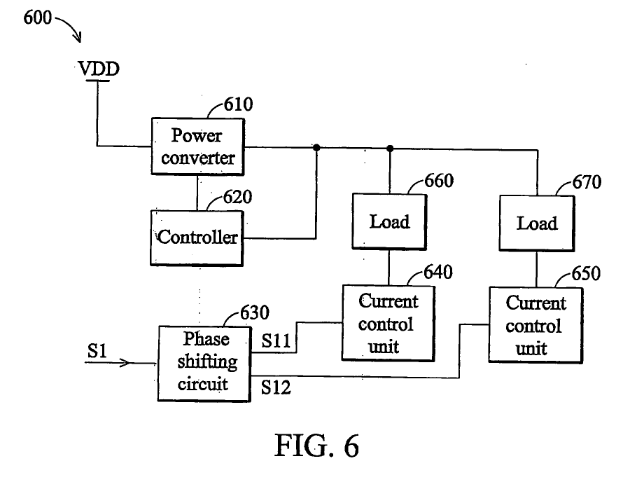

FIG. 6 is a block diagram of another embodiment of a control circuit 600 according to the invention. As shown in FIG. 6, the control circuit of this embodiment comprises a power converter 610, a controller 620, a phase shifting circuit 630 and current control circuits 640 and 650. The controller 320 generates a control signal, and the current control circuits 640 and 650, separately controls the current flow through the load 660 and 670 to turn on or off the load 660 and 670. The power converter 610 is coupled to the controller 620 and the loads 660 and 670, and converts an inputted voltage signal VDD to an output voltage signal according to the control signal. The controller 620 is coupled to the power converter 610 for adjusting the control signal according to the output voltage signal so as to keep the output voltage signal at a predetermined voltage level. It is to be noted that circuit configurations of the power converter 610, the controller 620 and the current control circuit 640 and 650 shown in block diagram 600 are similar to those of the power converter 310, the controller 320 and the current control circuit 330 shown in block diagram 300 and thus repeated descriptions are omitted for brevity.

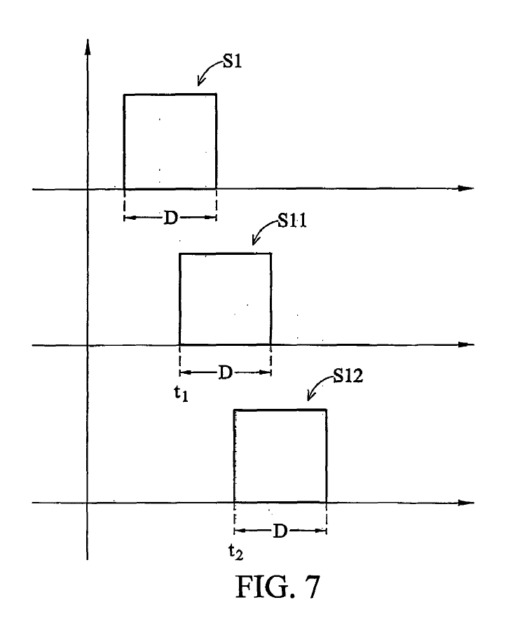

The phase shifting circuit 630 is coupled to the current control circuit 640 and 650 for generating a first control signal S11 with a first phase and a second control signal S12 with a second phase according to a dimming signal S1 to control the current flow through the loads 660 and 670, respectively, in which the first phase is different from the second phase. FIG. 7 is a schematic of an embodiment of a dimming signal according to the invention. As shown in FIG. 7, the phase shifting circuit 630 first generates a first control signal S11 at time t1 and then generates a second control signal S12 at time t2 according to the original dimming signal S1. The phase of the first control signal S11 is thus different than that of the second control signal S12. The first control signal S11 is utilized to control the current control circuit 640 to generate a responsive current to drive the load 660 while the second control signal S12 is utilized to control the current control circuit 650 to generate a responsive current to drive the load 670. Since loads 660 and 670 are operated in different phases, ripple wave of the output current from the power converter can be reduced and the performance of the power converter can be improved. It is to be understood that, in this embodiment, although the phase of the original dimming signal S1 is different than that of the first control signal, the phase of the original dimming signal S1 and the first control signal may be the same in other embodiments. Further, according to the present invention, the phase shifting circuit can be utilized to generate more control signals corresponding to the number of loads to be controlled with different phases to drive each of the loads so as to adjust the luminance of the load when the number of the loads to be controlled is increased.

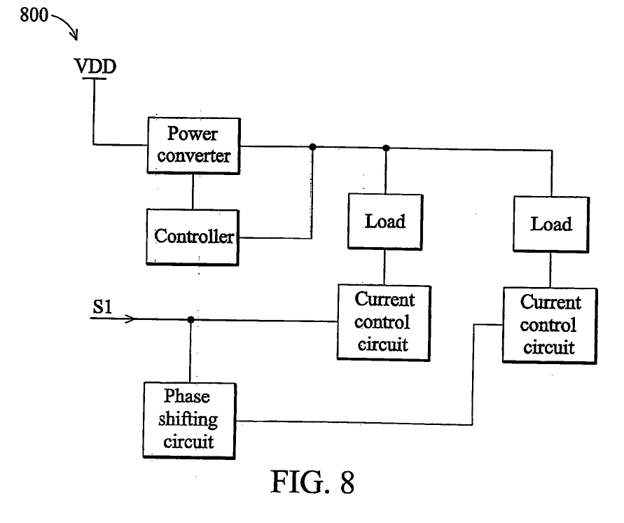

Furthermore, the dimming signal S1 may also be inputted to one of the current control circuits directly, and the control signal may be generated by the phase shifting circuit to control other current control circuits. FIG. 8 is a block diagram of yet another embodiment of a control circuit according to the invention. In this embodiment, the control circuit has first and second loads. As shown in FIG. 8, the controller generates a control signal and the power converter converts an inputted voltage signal VDD to an output voltage signal. The controller is coupled to the power converter and adjusts a control signal according to the output voltage signal for adjusting the voltage level of the output voltage signal such that the output voltage signal is kept in a predetermined voltage level. The current control circuit is utilized to control the current flow through the second load while the first current control circuit is directly controlled by the dimming signal. The phase shifting circuit generates a control signal having a phase other than that of a dimming signal S1. Therefore, the first and second current control circuits are controlled by the dimming signal and the control signal, respectively, to respectively control the current flow through the first and second loads. The first and second current control circuits may be current mirror circuits, and the power converter may be a buck converter or a boost converter, as examples. Again, as for the circuit configurations of the power converter, the controller and the current control circuits shown in FIG. 8 are similar to those of the power converter 310, the controller 320 and the current control circuit 330 shown in block diagram 300 and thus repeated descriptions are omitted for brevity.

When the aforementioned multi-phases dimming control circuit is implemented in a back-light module of the liquid crystal display (LCD), it can be combined with scan backlight techniques (i.e., each of the light emitting modules in the backlight module is turned on at different times) such that the phase shifting circuit receives a vertical scan signal Hsync from the LCD and generates a plurality of synchronized signals, each having a different phase, to each of the current control circuits so as to eliminate the ghosting image effect for the LCD.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. A control circuit for controlling a current flow through a load, comprising:
a power converter, converting a first voltage signal to a second voltage signal in response to a control signal;
a controller coupled to the power converter, adjusting the control signal in response to the second voltage signal such that the second voltage signal is held at a predetermined level; and
a current control circuit coupled to the load, controlling the current flow through the load according to a dimming signal.

2. The control circuit of claim 1, wherein the power converter comprises:
a switch, having a first input end receiving the first voltage signal, a second input end and a control end;
a rectifying device, having a first end coupled to the second input end of the switch;
an inductor, having a first end coupled to the first end of the rectifying device; and
a capacitor, having a first end coupled to a second end of the inductor,
wherein the control end of the switch receives the control signal and converts the first voltage signal to the second signal through the rectifying device, the inductor and the capacitor.

3. The control circuit of claim 1, wherein the controller comprises:
a feedback compensation circuit, comprising at least one capacitor;
an error amplifier, having a positive end coupled to a reference voltage and a negative end receiving the second voltage signal, wherein the error amplifier compares the second voltage signal and the reference voltage, and outputs an adjusting signal by the feedback control of the feedback compensation circuit;
a signal generator, generating a comparison signal;
a comparator, having a positive end receiving the adjusting signal and a negative end receiving the comparison signal for generating the control signal; and
a driving circuit coupled to the comparator, controlling the switch of the power converter by the control signal.

4. The control circuit of claim 1, wherein the current control circuit further forces the current flow through the load to be zero immediately when the dimming signal is a low level signal.

5. The control circuit of claim 1, wherein the current control circuit is a current mirror circuit.

6. A control circuit for controlling current flows through a first load and a second load, comprising:
a power converter, converting a first voltage signal to a second voltage signal in response to a control signal;
a controller coupled to the power converter, adjusting the control signal in response to the second voltage signal such that the second voltage signal is held at a predetermined level;
a first current control circuit coupled to the first load, controlling the current flow through the first load;
a second current control circuit coupled to the second load, controlling the current flow through the second load; and
a phase shift circuit, generating a first control signal with a first phase and a second control signal with a second phase other than the first phase in response to a dimming signal,
wherein the first current control circuit is controlled by the first control signal to control the current flow through the first load and the second current control circuit is controlled by the second control signal to control the current flow through the second load.

7. The control circuit of claim 6, wherein the power converter comprises:
a switch, having a first input end receiving the first voltage signal, a second input end and a control end;
a rectifying device, having a first end coupled to the second input end of the switch;
an inductor, having a first end coupled to the first end of the rectifying device; and
a capacitor, having a first end coupled to a second end of the inductor,
wherein the control end of the switch receives the control signal and converts the first voltage signal to the second signal through the rectifying device, the inductor and the capacitor.

8. The control circuit of claim 7, wherein the controller comprises:
a feedback compensation circuit, comprising at least one capacitor;
an error amplifier, having a positive end coupled to a reference voltage and a negative end receiving the second voltage signal from the power converter, wherein the error amplifier compares the second voltage signal and the reference voltage, and outputs an adjusting signal by the feedback control of the feedback compensation circuit;
a signal generator, generating a comparison signal;
a comparator, having a positive end receiving the adjusting signal and a negative end receiving the comparison signal for generating the control signal; and
a driving circuit coupled to the comparator, controlling the switch of the power converter by the control signal.

9. The control circuit of claim 6, wherein the first and second current control circuits further forces the first and second current flows through the first and second load, respectively, to be zero immediately when the dimming signal is a low level signal.

10. The control circuit of claim 6, wherein the first and second current control circuits are current mirror circuits.

11. The control circuit of claim 6, wherein the first and second loads are light emitting modules within the back-light module of a liquid crystal display (LCD) displaying plane, and the first control signal is synchronized with a vertical scan signal of the LCD displaying plane.

12. The control circuit of claim 6, wherein the current flow through the first and second loads are respectively controlled by the first and second current control circuits without feedback to the power converter and the controller.

13. A control circuit for controlling current flows through a first load and a second load, comprising:
a power converter, converting a first voltage signal to a second voltage signal in response to a control signal;
a controller coupled to the power converter, adjusting the control signal in response to the second voltage signal such that the second voltage signal is held at a predetermined level;
first and second current control circuits, respectively coupled to the first and second loads, controlling the current flow through the first and second loads, respectively; and
a phase shift circuit, generating at least one control signal with a phase other than the phase of the dimming signal in response to a dimming signal,
wherein the first current control circuit controls the current flow through the first load by the dimming signal, and the second current control circuit controls the current flow through the second load by the control signal.

14. The control circuit of claim 13, wherein the power converter comprises:
a switch, having a first input end receiving the first voltage signal, a second input end and a control end;
a rectifying device, having a first end coupled to the second input end of the switch;
an inductor, having a first end coupled to the first end of the rectifying device; and
a capacitor, having a first end coupled to a second end of the inductor,
wherein the control end of the switch receives the control signal and converts the first voltage signal to the second signal through the rectifying device, the inductor and the capacitor.

15. The control circuit of claim 14, wherein the controller comprises:
a feedback compensation circuit, comprising at least one capacitor;
an error amplifier, having a positive end coupled to a reference voltage and a negative end receiving the second voltage signal from the power converter, wherein the error amplifier compares the second voltage signal and the reference voltage, and outputs an adjusting signal by the feedback control of the feedback compensation circuit;
a signal generator, generating a comparison signal;
a comparator, having a positive end receiving the adjusting signal and a negative end receiving the comparison signal for generating the control signal; and
a driving circuit coupled to the comparator, controlling the switch of the power converter by the control signal.

16. The control circuit of claim 13, wherein the first and second current control circuits further forces the first and second current flows through the first and second load, respectively, to be zero immediately when the dimming signal is a low level signal.

17. The control circuit of claim 13, wherein the first and second current control circuits are current mirror circuits.

18. The control circuit of claim 13, wherein the first and second loads are light emitting modules within the back-light module of a liquid crystal display (LCD) displaying plane, and the first control signal is synchronized with a vertical scan signal of the LCD displaying plane.

19. The control circuit of claim 13, wherein the current flows through the first and second loads, are respectively controlled by the first and second current control circuits without feedback to the power converter and the controller.
